(19) United States
(12) Patent Application Publication
(10) Pub. No.: US 2025/0220125 A1
(43) Pub. Date: Jul. 3, 2025

(54) SYSTEM AND METHOD FOR PERFORMING A COLOR PREFLIGHT OPERATION

(71) Applicant: Esko Software BV, Gent (BE)

(72) Inventors: Frank Woltering, Gent (BE); David Butijn, Gent (BE)

(73) Assignee: Esko Software BV, Gent (BE)

(21) Appl. No.: 18/850,643

(22) PCT Filed: Mar. 24, 2023
(86) PCT No.: PCT/EP2023/057736

§ 371 Date: Sep. 25, 2024

Related U.S. Application Data
(60) Provisional application No. 63/323,805, filed on Mar. 25, 2022.

(51) Int. Cl. H04N 1/60; G06F 3/12

(52) U.S. Cl. CPC H04N 1/603; G06F 3/1205; G06F 3/1208; G06F 3/1255; G06F 3/1256

(57) ABSTRACT

Methods and systems for performing a color preflight operation. Press configurations are compared for conversion of a digital artwork design having color values and a color profile, each configuration associated with a press, a substrate, and a colorant set, and including a press-specific, substrate-specific color-profile and set of rules for converting any digital artwork design to that press configuration using that color profile. The design is converted in accordance with each press configuration, for all colors in the design, and a color output for each conversion is predicted in a selected device-independent colorspace. The predicted color output is compared against a comparison color output defined by the artwork color values expressed in the selected device-independent colorspace. Portions out of tolerance are identified and reported using a predetermined metric. A comparison image is generated and displayed highlighting out of tolerance portions and/or acceptable and/or optimal press configurations are automatically selected.

### CROSS REFERENCE TO RELATED APPLICATIONS

This application claims priority to U.S. Provisional Application Ser. No. 63/323,805, titled SYSTEM AND METHOD FOR PERFORMING A COLOR PREFLIGHT OPERATION, filed Mar. 25, 2022, incorporated herein by reference in its entirety.

### BACKGROUND OF THE INVENTION

The cost and productivity of a printing press is affected by how many colorants (inks) are used. Using relatively more colorants generally results in being able to reproduce a relatively larger color gamut, but also typically involves higher cost and, on at least some presses, a lower printing speed. Lower printing speed leads to less productivity of the press, overall, and may lead to inefficient use of the press. For example, printing with four inks instead of six costs 33% less and can be processed 33% faster on an HP® Indigo digital printing press. The difference in cost and productivity between using a digital press (e.g. an inkjet or an electrostatic press) and a non-digital press (e.g. a flexographic, offset lithographic, or gravure printing press that requires creating and using specific printing plates for each color separation) may also be affected by the number of colors used and the overall color gamut needed as well as the number of prints to be made of the intended design.

The optimal set of colorants is affected by the artwork design and acceptable color tolerances. Early identification of the colorant set is desirable for accurate estimation and job planning. By contrast, determining the optimal colorant set at the press may delay creation of the “make-ready plate” and decrease Overall Equipment Effectiveness (OEE)/productivity.

The following nomenclature is used throughout this application:
Colorspace: a definition of a format to store color data. Non-limiting examples include RGB, CMYK, and Lab (discussed in more detail below). For example, the RGB colorspace defines that each color consists of 3 components, where the first component represents red (R), the second component represents green (G), and the third component represents blue (B). Likewise, CMYK includes four components: Cyan (C), Magenta (M), Yellow (Y), and Black (B). CMYKOGV includes the additional components of Orange (O), Green (G), and Violet (V).
Color values or Ink densities: the actual values as defined using a selected colorspace. So, for example, 50% Cyan, 50% Magenta, 0% Yellow and 0% Black are color values defined in the CMYK colorspace that define a purple-ish color.
Device-dependent colorspaces: a colorspace in which each color value corresponds to a component used by the device to process and output the color (e.g. ink used by a press or a pixel color used by a display). Examples include the RGB and CMYK colorspaces. Color values defined in a device-dependent colorspace do not uniquely identify a color, because printing a color using different printers or displaying with different displays will typically result in similar but different colors printed or displayed, based upon the characteristics of the device, the colorants used, and the substrate (for printed output).
Device-independent colorspaces: a colorspace in which each set of color values defines a unique color that always looks exactly the same to the human eye. An example is the Lab colorspace.

The field of printing needs devices able to display/print/scan colors using the device-dependent colorspace as well as needs to define each unique color in an absolute way by using a device-independent colorspace. To overcome the mismatch between device-dependent and device-independent colorspaces, color profiles are used for translating color values from a device-dependent colorspace to color values in a device-independent colorspace and vice-versa.

Deviations in color matching are typically represented as a value of delta-E, which is an expression of the difference between the printed color and the original color standard of the input content. Relatively lower values for delta-E correspond to relative greater accuracy in the color match, whereas a relatively higher delta-E value signals a relatively greater mismatch. Color is typically measured using a spectrophotometer in three dimensions in a device-independent colorspace (also sometimes referred to as a “color model” or a “color scale”), such as but not limited to the L*, a*, and b* colorspace, as is discussed in more detail below. To calculate the delta-E variance from the produced color to the target, the variance (e.g. between printed color and design color) is measured along each axis, and in the most basic exemplary equation depicted below as shown in Equation 1, the variance is squared, the squares are totaled, and the square root of the total gives the delta-E variance.

delta-E=[(L*₂−L*₁)²+(a*₂−a*₁)²+(b*₂−b*₁)²]^{1/2} (1)

The above equation is sometimes referred to as CIE76, denoting the year (1976) in which it was developed. However, over time, more complex formulae have evolved for delta-E in attempts to improve how the relationship between the calculated result and actual human perception. Such more complex formulae are known among those of skill in the art as CIE94 (developed in 1994) and CIEDE2000 (developed in 2000). Other equations are known for use in different colorspaces, such as the CMC l:c (1984) equation for delta-E, which is expressed using the L*C*h color space. Another Lab colorspace includes the Hunter L, a, b colorspace. Accordingly, any reference to delta-E in this application is not limited to use of any particular formula. Likewise, although referenced herein primarily with respect to the L*a*b* color space as the exemplary device independent colorspace, the invention is not limited to use of any particular colorspace.

Current solutions in the marketplace, such as Esko® Color Preflight (ECP) software, predicts the maximum color impact for a given design, but limitations in evaluation of the true color deviation may cause suboptimal forecasting and may miss the opportunity for improved OEE. The current ECP software provides simulated metrics for a few key colors from the design, but not all colors. Specifically, the ECP software uses the spectral color information of the input inks and compares that with the best matching result of the output colorspace (i.e. the printer profile). However, because the current ECP solution limits this review of spectral color information to “solid” ink colors (colors that are not mixed with other colors), the output is a theoretical approach, and does not consider ink colors that are used only as a tint (mixed with a different color), for which being out-of-gamut causes less visual damage than in solid areas. Accordingly, the current ECP output does not consider color deviations that may be present in only a very small portion of the graphics, causing less to no visual damage.

To compensate for problems associated with accurately predicting color deviation, print shops may rely on only simple rules, rely on experts, or wait to decide on the press. Following only simple rules may result in print jobs being produced with more inks than are really needed, because of overestimation of delta-E in a tint area. Relying on experts tends may be expensive, subjective, and may insert additional delays into the printing process. Waiting to decide on press has the drawbacks discussed above. For all of the above reasons, there is a need in the art for better tools for helping print shops assess color deviations associated with various ink sets and choose among multiple alternatives.

### SUMMARY OF THE INVENTION

One aspect of the invention relates to a computer-implemented method for performing a color preflight operation. The method includes providing, with the computer, a subject digital artwork design having a first set of color values, a color profile associated with the digital artwork design, and a tolerance for color reproduction, and providing, with the computer, more than two press configurations. Each press configuration is associated with a press, a substrate, and a colorant set, and includes a press-specific, substrate-specific color-profile and a set of rules for automatically converting any digital artwork design to that press configuration using the press-specific, substrate-specific color profile. The method includes converting, with the computer, the subject digital artwork design in accordance with the corresponding set of rules for each of the plurality of press configurations, for all colors in the subject digital artwork design, and predicting a color output associated with each conversion corresponding to each press configuration. Each color output defines a set of press-configuration-specific converted color values expressed in a selected device-independent colorspace. Using the computer, the predicted color output associated with each conversion is compared to a comparison color output defined by the first set of color values mapped to or otherwise expressed in the selected device-independent colorspace. Any portion of the predicted color output that is out of tolerance is identified, and a metric, such as delta-E, defining a relative amount that the predicted color output is out of tolerance is reported.

The method further includes one or more of the following options. In a first option, the method includes for one or more selected conversions, generating and displaying a comparison image comprising an image corresponding to the subject digital artwork design with highlighting corresponding to each portion of the predicted color output that is out of tolerance. In a second option, the method includes automatically identifying with the computer one or more acceptable press configurations or automatically providing an alert indicating that none of the press configurations are acceptable based upon a first set of predetermined criteria, and optionally, automatically selecting from the acceptable press configurations an optimum press configuration based upon a second set of predetermined criteria.

In embodiments, the more than two press configurations may include at least one digital press configuration and at least one non-digital press configuration, or all of the more than two press configurations may include digital press configurations. The more than two press configurations may include at least one configuration for a different substrate than at least one other configuration. The more than two press configurations may include at least one configuration with a colorant set having fewer colorants than at least one other configuration in the plurality of press configurations, such as but not limited to, two or more of the following: at least one configuration having 3-colorants, at least one configuration having 4-colorants, at least one configuration having 5-colorants, at least one configuration having 6-colorants, and at least one configuration having 7-colorants.

Providing the tolerance for color reproduction may include identifying at least one first portion of the digital artwork design having a different tolerance than at least one second portion of the digital artwork. The portion having the different tolerance may, for example, be identified as an object or as a bounded area of the digital artwork design.

The metric defining the relative amount that the predicted color output associated each conversion is out of tolerance may comprise a value for total area out of tolerance. The method may include identifying one or more of the plurality of press configurations having a least total area value outside of tolerance. The total area value outside of tolerance may be expressed as a percentage of total area of the digital artwork design, in dimensional units squared, or in a combination thereof.

Comparing the predicted color output associated with each conversion against the subject digital artwork design may include calculating delta-E for each portion of the predicted color output. Embodiments may include receiving a user-input change in the tolerance, and re-displaying the color-managed image, revising the highlighting of each portion that is out of tolerance, and revising metric defining the relative amount out of tolerance for the user-input change in tolerance. The user-input change in tolerance may be received via a graphical user interface comprising a slide operable between relatively lower values and relatively higher values, a displayed numeric tolerance value modifiable by entering a different numeric value, or a combination thereof.

The comparison image may include a first color relative to the actual color of the subject digital artwork design in areas that are within tolerance and a second false coloration for the highlighting. The highlighting of each portion that is out of tolerance may be bounded by a highlight window, which may be in the actual color or in a third false coloration perceptively different than the second false coloration. The highlighting of each portion that is out of tolerance may be provided in a complementary or contrasting color to the actual color of the subject digital artwork design or in a user-selected color. The first false coloration may be dimmer or brighter than the actual color.

The method may include calculating a maximum delta-E and an average delta-E for the areas outside of tolerance for each of the press configurations, such as identifying acceptable maxima for maximum delta-E, average delta-E, and total area outside of tolerance, and comparatively reporting the maximum delta-E, average delta-E, and total area outside of tolerance for a plurality of press configuration relatively to the acceptable maxima. The method may further include identifying colorants of a colorant set having at least one press configuration with maximum delta-E, average delta-E, and total area outside of tolerance less than the respective identified acceptable maxima. The method may include providing in the user interface a list of one or more press configurations by name, with corresponding maximum delta-E, average delta-E, and total area outside of tolerance values associated with each press configurations listed in the user interface.

More generally, the method may include defining a maximum value, an average value, a total value, or a combination thereof, for the metric defining a relative amount that the predicted color output. Identifying one or more acceptable press configurations using the first set of predetermined criteria may include defines acceptable press configurations as those having a maximum value, average value, and total value less than identified acceptable maxima for each of the maximum value, average value, and total value for the metric defining a relative amount that the predicted color output. Selecting an optimum press configuration from the one or more acceptable press configurations using the second set of criteria may include defining the optimum press configuration as that which has (a) a lowest number of colorants as compared to any other of the one or more acceptable press configurations; (b) a least amount of area out of tolerance in a portion of the digital artwork design identified as being more critical than another portion of the digital artwork design, or (c) a combination of (a) and (b). Embodiments may include further comprising providing a cost estimate associated with each press configuration and ranking the press configurations by cost, wherein the second set of predetermined criteria for selecting the optimum press configuration defines the optimum press configuration as having a most cost-effective configuration.

Another aspect of the invention relates to a system for performing a color preflight operation, the system comprising a computer processor, one or more input devices operable to provide input to the computer processor, a computer display operable to display a visual image in accordance with commands executed by the computer processor, and computer memory media. The computer memory media is programmed with instructions for receiving via the one or more input devices, storing in the computer memory media, and/or retrieving from computer memory, a subject digital artwork design with a first set of color values, a color profile associated with the digital artwork design, and a tolerance for color reproduction. The media is further programmed with instructions for receiving via the one or more input devices, storing in the computer memory media, and/or retrieving from computer memory, two or more press configurations, each press configuration associated with a press, a substrate, and a colorant set, and including press-specific, substrate-specific color-profile and a set of rules for automatically converting any digital artwork design to that press configuration using the press-specific, substrate-specific color-profile. The programmed instructions further includes instructions for converting, with the computer processor, the subject digital artwork design in accordance with the corresponding set of rules for each of the plurality of press configurations, for all colors in the subject digital artwork design; predicting, with the computer processor, a color output associated with each conversion corresponding to each press configuration (each color output defining a set of press-configuration-specific converted color values expressed in a selected device-independent colorspace); and comparing, with the computer processor, the predicted color output associated with each conversion against a comparison color output defined by the first set of color values mapped to or otherwise expressed in the selected device-independent colorspace, identifying any portion of the predicted color output that is out of tolerance, and reporting a metric defining a relative amount that the predicted color output is out of tolerance. The media further includes at least one of: programmed instructions for, with respect to one or more selected conversions, generating with the computer processor and displaying on the display, a comparison image comprising an image corresponding to the subject digital artwork design with highlighting corresponding to each portion of the predicted color output of the design that is out of tolerance; or programmed instructions for automatically identifying with the computer one or more acceptable press configurations or automatically providing an alert indicating that none of the press configurations are acceptable based upon a first set of predetermined criteria, and optionally, automatically selecting from the acceptable press configurations an optimum press configuration based upon a second set of predetermined criteria.

The system processor may be further configured to automatically identify one or more acceptable press configurations, each acceptable press configuration having a maximum value, average value, total value, or a combination thereof for the metric defining the relative amount that the predicted color output, that is less than identified acceptable maxima for the respective values. The process may further be configured to automatically select an optimum press configuration from the one or more acceptable press configurations, wherein the optimum press configuration has (a) a lowest number of colorants as compared to any other of the one or more acceptable press configurations; (b) a least amount of area out of tolerance in a portion of the digital artwork design identified as being more critical than another portion of the digital artwork design, or (c) a combination of (a) and (b). Embodiments of the system may include the processor being configured to provide a cost estimate associated with each press configuration and rank the press configurations by cost, wherein the second set of predetermined criteria for selecting the optimum press configuration defines the optimum press configuration as having a most cost-effective configuration.

Still another aspect of the invention relates to non-transitory computer memory media programmed with machine readable instructions for causing a computer processor to perform a color preflight operation in accordance with the instructions described with respect to the above system.

### BRIEF DESCRIPTION OF THE DRAWING

The patent or application file or priority application file and any national phase applications thereof that permit color contain or will contain at least one drawing executed in color. Where applicable, copies of this patent or patent application publication with color drawing(s) will be provided by the Office upon request and payment of the necessary fee. Colors described herein are for illustration only, and correspond to shades of gray in the corresponding grayscale drawings. Content (e.g. text, graphics, colors) in FIGS. 2, 3, 7 (and the portion of FIG. 4 analogous thereto) are exemplary and for illustration only, and form no part of the invention.

FIG. 1 is a flowchart depicting an exemplary method in accordance with an aspect of the invention.

FIG. 2 depicts an exemplary digital artwork design, comprising colored areas primarily in shades of green and yellow.

FIG. 3 depicts an exemplary comparison image, showing a relatively dimmed tone for portions of the image not out of tolerance, a highlight window having a relatively brightened tone, and out of tolerance areas in a red or orange color relative to the generally green intended colors of the image portion.

FIG. 4 depicts an exemplary user interface display.

FIG. 5 depicts an exemplary portion of the user interface for receiving user input for the tolerance.

FIG. 6 is a schematic diagram of an exemplary system in accordance with an aspect of the invention.

FIG. 7 depicts an exemplary comparison image showing a relatively brightened tone for portions of the image not out of tolerance and out of tolerance areas in a blue color relative to the generally green intended colors of the image portion.

FIG. 8 is a schematic diagram illustrating the conversion and comparison steps as described herein.

### DESCRIPTION OF THE INVENTION

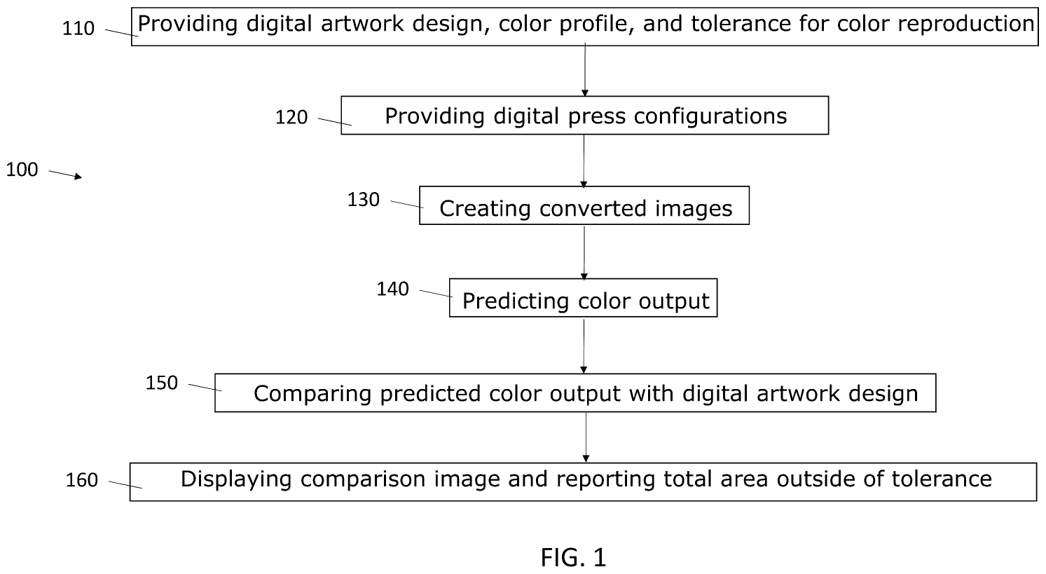

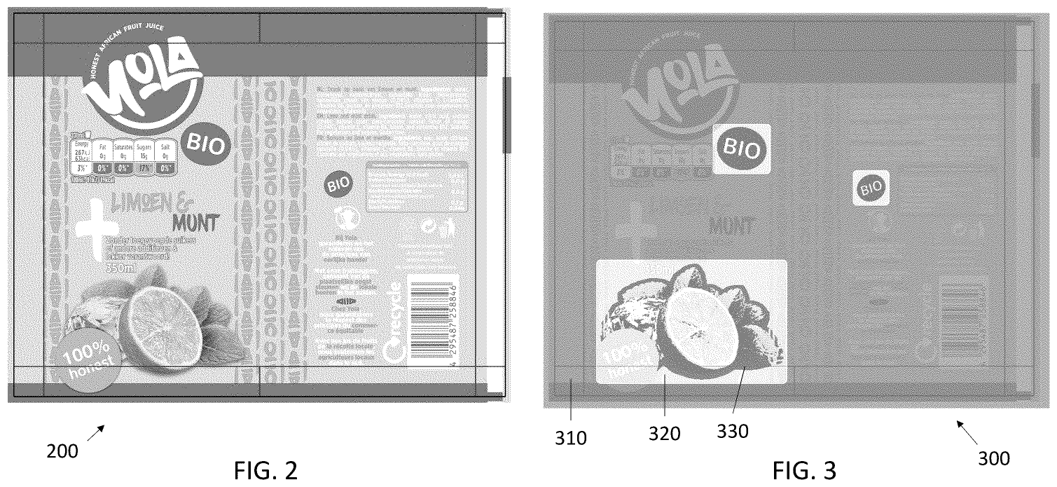

Referring now to the figures, one aspect of the invention relates to a method 100, as depicted in FIG. 1, for performing a color preflight operation. The method includes, in step 110, providing a subject digital artwork design, a color profile associated with the digital artwork design, and a tolerance for color reproduction. As is known in the art, a color profile is a characterization of a device that converts values from a device-dependent colorspace (typically RGB and CMYK) to a device-independent colorspace (such as but limited to L*a*b*). The color profile provided in this step may be a device-dependent color profile, such as a profile intended for use for printing on a specific press known for use by the artwork designer, or it may be a device-independent profile, such as a standardized CMYK or standardized RGB profile, or may be a device-independent profile (such L*a*b*). For example, design 200 as depicted in FIG. 2 may be a subject digital artwork design to be printed on a substrate. The color profile may comprise information sufficient to fully describe the intended output, given the color information for each area of the design, provided in a standard, such as CMYK, RGB, sRGB, or L*a*b*, without limitations.

Step 120 includes providing a plurality of, preferably more than two, press configurations. Each press configuration is associated with a specific press, a substrate, and a colorant set, and includes substrate-dependent color-profile information associated with the specific press for the specific substrate, and a set of rules for automatically converting any design to that configuration. For example, an exemplary such rule set may define a conversion as performed by a color management module (CMM), matching the design color profile to the press color profile. More complex rule sets may describe how some elements of the artwork design are to be converted differently than others (e.g. different rules for text vs. images). The color-profiling information is sufficient to predict how colors are to be reproduced using the colorants in the colorant set—specifically including details of the relative amounts of each colorant that will be used to create each color. In some embodiments, all of the press configurations may be digital press configurations, and in other embodiments, at least one of the press configurations may be associated with a non-digital press (e.g. a flexographic press that requires generating printing plates).

Step 130 includes converting the digital artwork design in accordance with the corresponding set of rules for all colors in the subject digital artwork design, for each of the plurality of press configurations. Unlike prior art solutions, the conversion is performed for all of the colors in the converted image, rather than only for key colors.

Step 140 includes predicting a color output, such as with a color-managed image, associated with each conversion, and in step 150, comparing each predicted color output with the subject digital artwork design (which may also be in the form of a color-managed image). As used herein the term “color-managed image” corresponds to an image in which each portion of the image has corresponding color information associated with each pixel, as well as a color profile associated with the image. The prediction step typically involves a use of curves/equations and/or a look up table. Accordingly, for example, each pixel in the image may have CMYK color information associated with it, or for a vector-based image, each area formed by the vector instructions may has color information associated with it. The comparison step may include calculating delta-E for each portion of the predicted color image (e.g. each pixel) as compared to each corresponding portion of the digital artwork design. In essence, the prediction step in 140 comprises taking the color values as converted from the first set of artwork color values in step 130, to color values corresponding to the colorants to be used by the press using the press-specific color profile on the selected substrate, mapped to a selected device-independent colorspace. The predicted color output of the press is then compared to the original artwork color values as expressed in or converted directly to the selected device-independent colorspace.

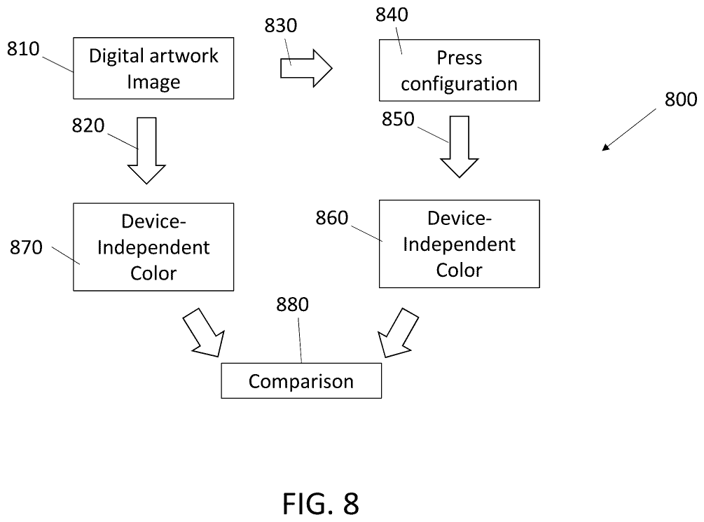

Referring now to FIG. 8, diagram 800 further illustrates the conversion and comparison steps. The color artwork design 810 includes a first color profile that maps the color values as expressed in the design to color values in a device independent colorspace 870. If the design 810 already has a device independent color space, then no conversion step 820 may be necessary (or conversion step 820 may be required to convert values from one device independent colorspace to values in the selected colorspace 870 used for comparison). The color values in the artwork design may be first converted using the artwork color profile in step 830 to a colorspace used by an expected output device, or to a device-independent colorspace. The color output of the press configuration is then predicted using conversion 850 of the values generated in step 830 to values in a device independent colorspace 860 in the same colorspace as the values in 870. In embodiments in which the color values in the artwork design are already provided in a device-independent color space, no step 830 may be required. In embodiments in which the press configuration is configured to accept values in the device-independent colorspace 870, the application of the press configurations 840 may start with the values generated in colorspace 870. The color values defined in the device-independent colorspace 860 and 870 are then compared in comparison block 880, which may employ one of the delta-E comparison formulae as described herein above.

Step 160, includes generating and displaying a comparison image comprising an image corresponding to the subject digital artwork design with highlighting corresponding to each portion of the design that is out of tolerance, and reporting a value for total area outside of tolerance.

For example, as shown in FIG. 3, in one embodiment, the comparison image 300 comprises providing relatively less color-saturated image areas or dimmed areas (such as by adding some percentage of black on top of the intended color) 310 relative to the actual color of the color-managed image (as depicted in FIG. 2) in areas that are within tolerance, such as by using a modified color profile for displaying the non-highlighted portion of the image. This difference in color from the actual color may be described as a “false coloration,” meaning that it differs in some way from the actual coloration. As depicted in FIG. 3, the first false coloration corresponding to the in-tolerance region 310 essentially comprises applying a relatively dimmer or blacker color profile to the display for that region. The highlighting of each portion that is out of tolerance, which can be defined as corresponding to a second false coloration, is bounded by a highlight window 320. The image areas within the highlight window that are in tolerance are depicted as relatively more color-saturated in at least one color (or brighter) than the actual coloration of the color-managed image (but in other embodiments, could be the actual coloration). Thus, as depicted, the relatively brighter coloration in the highlight window may be created by applying a relatively brighter color profile to the portion of the display corresponding to the in-tolerance regions inside the highlight window. Each portion that is out of tolerance is provided in a complementary or contrasting coloration 330 to the actual coloration in the color-managed image. Thus, as shown in FIG. 3, the highlight windows are relatively more yellow than the light green shaded area in the corresponding area of the subject design image and the out-of-gamut areas are shown in a red-orange hue, rather than in the actual color green, and the non-highlighted portions of the image are generally grayer than the colors depicted in FIG. 2. In other embodiments, the out-of-tolerance highlight coloration may be user-defined and may not necessarily be a complementary coloration. In particular, the user-defined coloration may be selected to be a color that is not present in the actual image, so as not to be confused with genuine coloration. In some embodiments, the highlight coloration may be selected by the computer as a coloration that is not one of the genuine colorations used in the design, and as distinguishable as possible from the nearest genuine colorations in the design. Distance between colorations may be based upon locations of the respective colorations on a standardized color wheel and relative distances on that wheel.

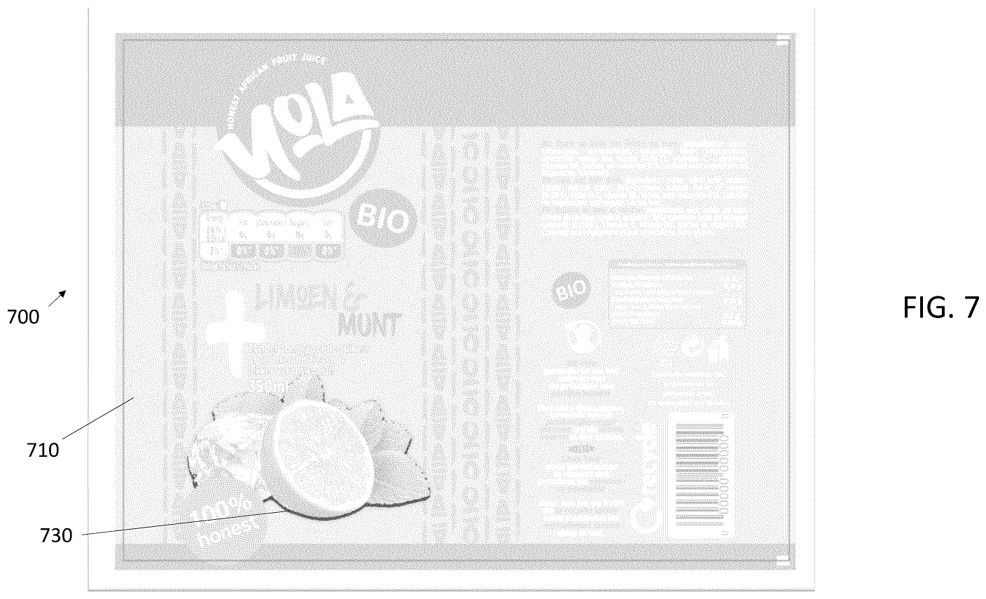

FIG. 7 illustrates another exemplary user interface display showing another exemplary comparison image 700, in which the majority of the image 710 (which is not out of tolerance) as a whole is relatively brighter than the actual coloration as depicted in FIG. 2, and the highlighted areas 730 corresponding to out of tolerance areas are depicted in blue. The blue may be user defined, or otherwise selected to stand out relative to the background tone. The invention is not limited to any particular manner of highlighting. As depicted in FIG. 7, there is no highlight window, just a first false coloration (e.g. brightened) for the in-tolerance portion of the image, and a second false coloration (e.g. blue) for the out-of-tolerance portion of the image.

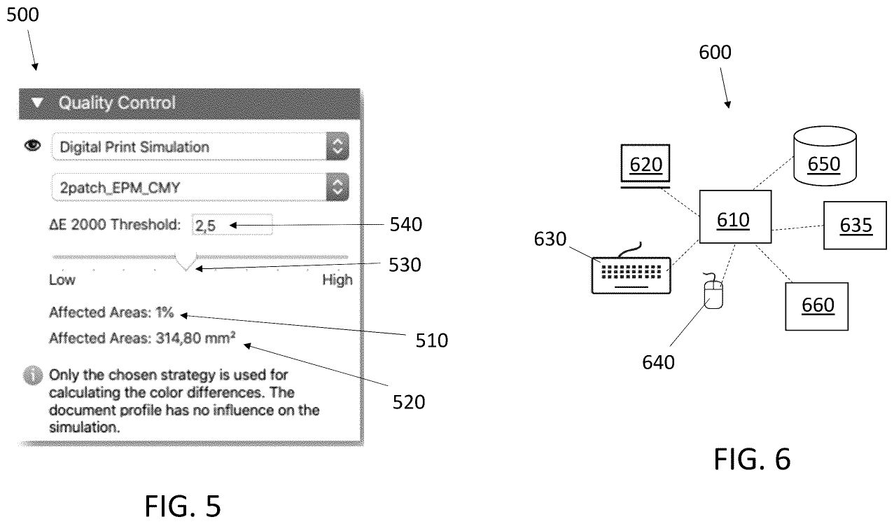

In some embodiments, the out-of-tolerance coloration may be expressed as a heat map in which relatively greater out-of-tolerance colors are shown in a different shade or tone of the highlight coloration than relatively less out-of-tolerance coloration, which heat map may comprise a continuous gradient from “cool” (less out of tolerance) to “hot” (more out of tolerance) areas or may have pronounced boundaries between designated ranges of relatively cooler to relatively hotter colors. In other embodiments, the highlight coloration may consist of a single color (e.g. the red-orange of FIG. 3 or the blue of FIG. 7). As shown in FIG. 5, the value reported for the total area outside of tolerance is expressed in an exemplary user interface window 500 as a percentage of total area of the digital artwork design 510 (e.g. 2,65% in European format; 2.65% in US format) as well as in dimensional units squared 520 (e.g. 557.13 mm²). It should be understood that the metric for reporting area outside of tolerance may be any metric selected to provide a meaningful output, and may be user selected from a number of choices. Units may be expressed in any unit of measure and may be user-selectable between unit conventions, and decimal nomenclature may also be selectable between European or US format.

The method may include automatically identifying one or more of the plurality of press configurations having a least total area value outside of tolerance, or a plurality of press configurations may be ranked by total area value outside of tolerance from least to worst, and several of the top (least value) contenders displayed in the user interface. In preferred embodiments, three or more press configurations are compared, including at least configurations with 3 colorants (e.g. CMY or CMK), 4 colorants (e.g. CMYK), 5 colorants (e.g. CMYK plus any one or OGV), 6 colorants (e.g. CMYK plus any two of OGV) or 7 colorants (e.g. CMYKGOV), but there is no limitation to the number of colorants to be included in the comparisons, and the foregoing color selections are non-limiting. For example, the colorants may include one or more “spot colors,” such one or more specific ink colors important to the branding associated with certain consumer packaging (e.g. a colorant in PANTONE® Coke red™ for use in connection with packaging printed for Coca-Cola®). Furthermore, there is no limit with respect to the types of colorants considered (e.g. the presence or absence of white underprint, gloss overprint, metallic colors, neon colors, etc. all may be included in the compared configurations). As used herein, the term “colorant” refers to any substance applied by the printing press that has an impact on the perception of color by a human viewer, including transparent substances such as “gloss.” Configurations using different substrates may also be compared, as may be configurations using digital versus non-digital presses.

The method typically includes generating a report for at least 3 configurations. In some use operations, the “winning” (i.e. optimal) configuration may be clear and readily selected automatically, particularly if the least cost, most efficient option is clearly in tolerance (i.e. identified as an acceptable configuration). In such operations, it may not be necessary for a viewer to review the display with highlighting. In other use operations, there may be two or more close candidate press configurations automatically identified to be acceptable that may benefit from human review to select the one perceived to be the best, based upon a review of the highlighted display. In other operations, the user may wish to review where the candidates are out of tolerance in each instance, or there may be no option automatically identified as acceptable, in which case the system may provide an alert that requires human review, or the human user may just want to review the computer-selected option before proceeding.

The highlighting in the comparison image provides metrics for a printer to make a subjective determination as to whether the affected area that is out of gamut and the degree to which it is out of gamut is critical to the overall image. The plurality of press configurations may include at least one configuration with a colorant sets having fewer colorants than at least one other configuration in the plurality of press configurations. In this way, the impact of different colorant sets can be compared objectively against one another by the metrics such as total area out of tolerance, while still also permitting the printer to subjectively consider whether the areas out of tolerance are visibly critical.

In still other embodiments, the evaluation of relative acceptability of out-of-tolerance areas may be further automated by pre-selecting certain portions of the image as having higher or lower importance. For example, such an identification may include identifying objects, such as the company logo, or an areas bounded by a user-defined boundary, such as a most important portion of the artwork, as having higher importance. If such areas are identified, the output may further provide metrics showing whether or how much of the out-of-tolerance area is located in a critical or non-critical area and/or an automated configuration selection may consider these critical areas when selecting the preferred design, with the user interface further identifying the critical or non-critical areas in the highlighted display. The consideration of critical vs. non-critical areas in the context of color tolerance may be expressed as a dynamic delta E (e.g. the maximum delta E for the identified object or area may be relatively higher than for remaining areas of the artwork), and there may be more any number of different areas or objects with different delta E thresholds identified within the artwork. The identification of important areas may be human-identified, or identified by a machine-learning algorithm trained to identify critical portions of images based upon programmed criteria.

In embodiments that automatically select an optimum configuration from a plurality of acceptable candidates, the acceptable candidates may be defined as those with the least number of colorants, or as those with no, or the least amount of, out-of-tolerance regions within in critical areas, or some combination thereof. For designs in which critical regions and least colorants both have importance, the applicability of each of these criteria may be weighted and evaluated as part of an algorithm, which may be user defined, or defined by machine leaning over time.

As shown in FIGS. 3, 4, and 5, software programmed with instructions for carrying out the above method may include a user interface for visualizing results and inputs. For example, as shown in FIG. 5, the user interface may be configured to permit a user to enter a change in the tolerance via a graphical user interface comprising a slide 530 operable between relatively lower values and relatively higher values and includes a display field 540 for displaying a numeric tolerance value (e.g. “δE 2000 Threshold: 2.5”). Thus, the user may change the value by moving the slide (e.g. with a mouse or a touch screen motion), or by entering a different numeric value in the relevant field. Changes in the value may then cause all of the forgoing steps to be repeated for each of the press configurations, and in particular, to display the changes with respect to a specific configuration currently being displayed, by re-displaying the color-managed image, revising the highlighting of each portion that is out of tolerance, and revising the total area value outside of tolerance for the user-input change in tolerance. The user interface may provide one or more warnings or informational statements, such as is depicted in FIG. 5, which notifies the user that “Only the chosen strategy is used for calculating the color differences. The document profile has no influence on the simulation.” This statement reflects that because the document profile is used both for providing the comparison values in the device- independent colorspace, and for converting the document color values to those used when applying the press configuration, any impact of the document profile is canceled out in the ensuing calculations and conversions.

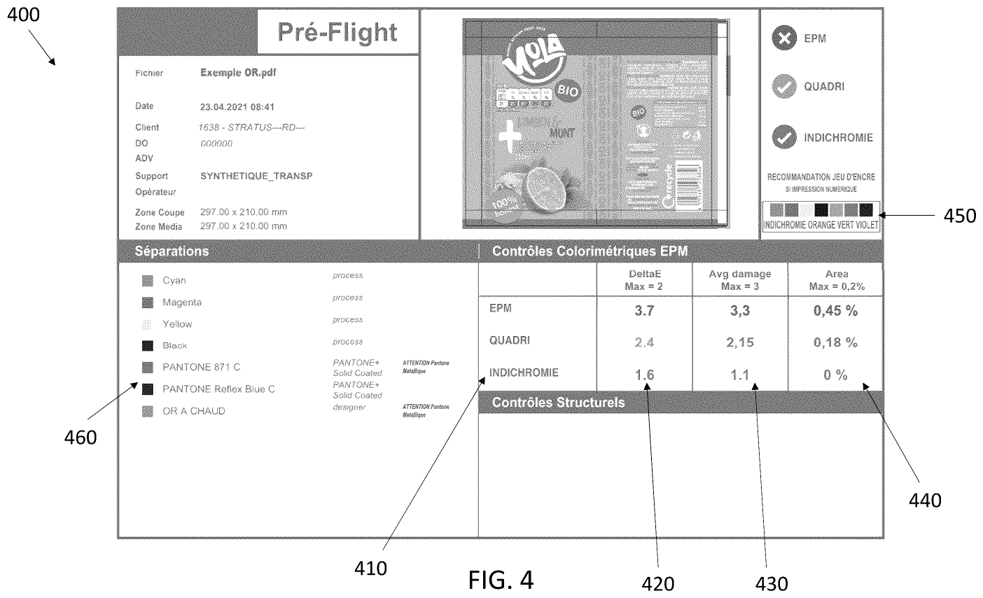

As shown in more detail in FIG. 4, the method may include providing in the user interface 400 a list 410 of one or more press configurations by name (e.g. “EPM”; “QUADRI”; and “INDICHROMIE”). The method may also comprise calculating and displaying a column 420 for maximum delta-E (e.g. “3.7” for “EPM”) and a column 430 for average delta-E (e.g. “3.3” for “EPM”) associated with each press configuration listed in the user interface. The user may set corresponding maxima for the maximum delta-E (e.g. “Max=2”), average delta-E (e.g. “Max=3”), and total area outside of tolerance values (e.g. “Max=0.2%) in column 440, and the values associated with each press configuration may be provided with color coding (e.g. green for good, red for bad) representing their relationship to the maxima. For example, as depicted in FIG. 4, the values for the EPM configuration are all in red because they are above the respective maxima, and the values for the INDICHROMIE configuration are all in green because they are below the respective maxima. The value for maximum delta-E for “QUADRI” (e.g. “2.4”) is depicted in yellow, which may signify that it exceeds the maximum value (e.g. 2), but only within a predetermined range, meaning that a close inspection of the comparison image may allow the user to decide whether the risks of this incremental amount of color damage outweighs any additional costs of choosing other options. As noted above, the metric used for reporting out of tolerance is not limited to any particular metric, and whatever metrics are selected may have corresponding maxima associated therewith for use in comparing the predicted output of candidate configurations against one another.

As further shown in FIG. 4, the colorant set 450 associated with configuration INDICHROMIE is depicted and identified as the recommended set of colorants. A list of separations 460 relating to identified INDICHROMIE press configuration is also provided. Each separation is identified as a “process” color, or by type of “spot” color (e.g. PANTONE® Solid Coated; designer), and additional color information may be provided, such as a color warning (“ATTENTION Pantone metallique”). The user interface also provides information regarding the file name (“Exemple OR.pdf”), a timestamp associated with the file (e.g. date and time the filed was last modified or saved), client information, substrate information (“Support SYNTHETIQUE_TRANSP”), operator information, and size information for the intended printed result, as well as for any portion that is being reviewed.

The output as discussed herein permits a printing press operator to select the most efficient configuration early in the printing workflow, and enables more accurate planning and cost estimation.

An exemplary system 600 for implementing aspects of the invention are depicted schematically in FIG. 6. Such a system includes a computer processor 610 connected to a display 620 and one or more input devices, such as user inputs include a keyboard 630 and a mouse 640, or any source 635 for receiving input, such as a database file stored in a memory or a machine-readable file imported over a network from an external source or from portable machine-readable media (a DVD, a flash drive, etc.), the file containing information relevant to the method as described herein, including but not limited to a color profile, a digital artwork design, a press configuration, or any of the above. The computer processor 610 is connected to computer memory 650, which memory comprises media programmed with machine-readable instructions for performing the method as described herein. A digital printing press 660 may also be connected to the processor. System 600 is not necessarily the system that operates the press 660, and may operate independently of the press to process the information as described herein. In such systems, the actual printing execution is performed by a different system which may have some or all of the same features as described with respect to system 600. The various components of the systems as described herein may be local to one another, distributed across a network, such as a global communications network, or some combination thereof.

Thus, system 600 includes computer memory media, the computer memory media programmed with instructions for receiving via the one or more input devices, storing in the computer memory media 650, and/or retrieving from computer memory the subject digital artwork design 200, a color profile associated with the digital artwork design, and a tolerance for color reproduction. It should be understood that an exemplary system may be capable of performing all of the foregoing functions, including receiving the relevant information from an input device, storing the information in memory, and retrieving the information from memory when required for the processing steps described in further detail below. The instructions also include instructions for storing in the computer memory media a plurality of press configurations, each press configuration associated with a press, a substrate, and a colorant set, and including color-profiling information and a set of rules for automatically converting any digital artwork design to that configuration. The instructions further include instructions for converting, with the computer processor, the subject digital artwork design in accordance with the corresponding set of rules for each of the plurality of press configurations, for all colors in the subject digital artwork design. The instructions include instructions for predicting, with the computer processor, a color output associated with each conversion corresponding to each press configuration; comparing, with the computer processor, the predicted color output associated with each conversion against the subject digital artwork design; and generating with the computer processor and displaying on the display, a comparison image comprising an image corresponding to the subject digital artwork design with highlighting corresponding to each portion of the design that is out of tolerance, and reporting a value for total area outside of tolerance. Another aspect of the invention includes non-transitory computer memory media programmed with machine readable instructions for causing a computer processor to performing a color preflight operation as described above. Such non-transitory computer media may be portable media (e.g. a flash drive or optical or magnetic memory disk storage), a server from which the instructions or portions thereof may be downloaded by users for local storage, a hard drive on which the instructions are locally stored and accessible, or a combination of local memory storage and internet accessible instructions stored “in the cloud.” Computer systems programmed with the instructions as described herein are specially programmed to perform the various functions and method steps as described.

The instructions, programming, or application(s) may be software or firmware used to implement the device functions associated with the device such as the scanners, printers and PCs described throughout this description. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into the source/destination PC and/or source/destination printer.

Other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

It should be understood that the figures as shown herein may depict only certain elements of an exemplary system, and other systems and methods may also be used. Furthermore, even the exemplary systems may comprise additional components not expressly depicted or explained, as will be understood by those of skill in the art. Accordingly, some embodiments may include additional elements not depicted in the figures or discussed herein and/or may omit elements depicted and/or discussed that are not essential for that embodiment. In still other embodiments, elements with similar function may substitute for elements depicted and discussed herein.

Any of the steps or functionality of the system and method for converting graphic files for printing can be embodied in programming or one more applications as described previously. According to some embodiments, “function,” “functions,” “application,” “applications,” “instruction,” “instructions,” or “programming” are program(s) that execute functions defined in the programs. Various programming languages may be employed to create one or more of the applications, structured in a variety of manners, such as object-oriented programming languages (e.g., Objective-C, Java, or C++), procedural programming languages (e.g., C or assembly language), or firmware. In a specific example, a third party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as ±10% from the recited amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected may lie in less than all features of any single disclosed example. Hence, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts. Thus, although the invention is illustrated and described herein with reference to specific embodiments, the invention is not intended to be limited to the details shown. Rather, various modifications may be made in the details within the scope and range of equivalents of the claims and without departing from the invention.

1. A computer-implemented method for performing a color preflight operation, the method comprising:
(a) providing, with a computer, a subject digital artwork design having a first set of color values, a color profile associated with the digital artwork design, and a tolerance for color reproduction;
(b) providing, with the computer, more than two press configurations, each press configuration associated with a press, a substrate, and a colorant set, and including a press-specific, substrate-specific color-profile and a set of rules for automatically converting any digital artwork design to that press configuration using the press-specific, substrate-specific color profile;
(c) converting, with the computer, the subject digital artwork design in accordance with the corresponding set of rules for each of the plurality of press configurations, for all colors in the subject digital artwork design;
(d) predicting, with the computer, a color output associated with each conversion corresponding to each press configuration, each color output defining a set of press-configuration-specific converted color values expressed in a selected device-independent colorspace;
(e) comparing, with the computer, the predicted color output associated with each conversion against a comparison color output defined by the first set of color values mapped to or otherwise expressed in the selected device-independent colorspace, identifying any portion of the predicted color output that is out of tolerance, and reporting a metric defining a relative amount that the predicted color output is out of tolerance; and
one or both of:
(f) for one or more selected conversions, generating with the computer and displaying on a computer display, a comparison image comprising an image corresponding to the subject digital artwork design with highlighting corresponding to each portion of the predicted color output that is out of tolerance;
(g) with the computer, automatically identifying one or more acceptable press configurations or automatically providing an alert indicating that none of the press configurations are acceptable based upon a first set of predetermined criteria, and optionally, automatically selecting from the acceptable press configurations an optimum press configuration based upon a second set of predetermined criteria.

2. The method of claim 1, wherein the more than two press configurations comprises at least one digital press configuration and at least one non-digital press configuration.

3. The method of claim 1, wherein all of the more than two press configurations comprise digital press configurations.

4. The method of claim 1, wherein the more than two press configurations comprises at least one configuration for a different substrate than at least one other configuration.

5. The method of claim 1, wherein the more than two press configurations includes at least one configuration with a colorant set having fewer colorants than at least one other configuration in the plurality of press configurations.

6. The method of claim 5, wherein the more than two press configurations comprises two or more of: at least one configuration having 3-colorants, at least one configuration having 4-colorants, at least one configuration having 5-colorants, at least one configuration having 6-colorants, and at least one configuration having 7-colorants.

7. The method of claim 1, wherein providing the tolerance for color reproduction includes identifying at least one first portion of the digital artwork design having a different tolerance than at least one second portion of the digital artwork.

8. The method of claim 7, wherein the at least one first portion is identified as an object or as a bounded area of the digital artwork design.

9. The method of claim 1, wherein the metric defining the relative amount that the predicted color output associated each conversion is out of tolerance comprises a value for total area out of tolerance.

10. The method of claim 1, further comprising identifying one or more of the plurality of press configurations having a least total area value outside of tolerance.

11. The method of claim 1, wherein comparing the predicted color output associated with each conversion against the subject digital artwork design comprises calculating delta-E for each portion of the predicted color output.

12. The method of claim 1, further comprising receiving a user-input change in the tolerance, and re-displaying the color-managed image, revising the highlighting of each portion that is out of tolerance, and revising metric defining the relative amount out of tolerance for the user-input change in tolerance.

13. The method of claim 12, wherein the user-input change in tolerance is received via a graphical user interface comprising a slide operable between relatively lower values and relatively higher values, a displayed numeric tolerance value modifiable by entering a different numeric value, or a combination thereof.

14. The method of claim 1, comprising depicting in the comparison image areas that are within tolerance in a first false coloration relative to the actual coloration of the subject digital artwork design and depicting the highlighting in a second false coloration.

15. The method of claim 1, further comprising bounding the highlighting within a highlight window having the actual color of the subject digital artwork design or a third false coloration relative to the actual color of the subject digital artwork design, wherein the third false coloration is perceptively distinguishable from the first false coloration and the second false coloration.

16. The method of claim 15, wherein the first false coloration is dimmer or brighter than the actual coloration.

17. The method of claim 1, wherein the highlighting of each portion that is out of tolerance is provided in a color that is complementary or contrasting relative to the actual coloration of the subject digital artwork design or a user-selected coloration.

18. The method of claim 1, wherein the total area value outside of tolerance is expressed as a percentage of total area of the digital artwork design, is expressed in dimensional units squared, or a combination thereof.

19. The method of claim 1, further comprising defining a maximum value, an average value, a total value, or a combination thereof, for the metric defining a relative amount that the predicted color output.

20. The method of claim 1, wherein the metric defining the relative amount that the predicted color output is out of tolerance comprises delta-E.

21.-33. (canceled)
